(19) United States
(12) Patent Application Publication
(10) Pub. No.: US 2011/0113565 A1
(43) Pub. Date: May 19, 2011

(54) Hammer head attachment and combination tool

(76) Inventor: Everett Lester Huffman, Bend, OR (US)

(21) Appl. No.: 12/590,764

(22) Filed: Nov. 13, 2009

(51) Int. Cl. B25D 1/00

(52) U.S. Cl. 7/144; 81/20

(57) ABSTRACT

The present invention is an attachment device that can be placed upon a tool, preferably a cable cutting tool, which replaces a hammer in an electrician's tool supply or eliminating the need for an electrician to carry a hammer around a job site. The attachable hammer head is made from a solid piece of metal in which there is flat hammer head with a set of flanges on the opposite side of the hammer head in which there is a channel between the flanges and one or more threaded holes within the flanges. The back blade of the wire cutters is placed within the channel and a set screw is in the one or more threaded holes. The set screws are tightened onto the blade affixing the solid mass of metal onto a wire cutter and allowing the user to efficiently use one tool for hammering wire cutting. The attachable hammer head is able to be removed as needed by the user.

### CROSS REFERENCE TO RELATED APPLICATION

None.

### BACKGROUND OF THE INVENTION

The present invention relates to and fulfills a need for a tool that can replace an electrician's hammer and a cable cutter. When electricians are roughing in outlets, boxes, wiring and other components of during a construction project, the electrician would like to save time and therefore money by having to carry fewer tools and getting more use out of the tools that they carry with them. The present invention can be used as an attachment for a current tool, preferably a wire cutting tool or the present invention can be manufactured and sold as a complete unit. The attachment device is placed on an existing tool and provides the electrician or worker with a tool that can pound nails, staples, and other hammering functions with a tool that can be used for cutting, pulling, and stripping wire. This combination can be used to save the worker time and money by letting the worker complete multiple tasks associated with wiring during construction or wiring work.

There are many types of combination tools in the prior art. U.S. Pat. No. 5,575,029, titled Combination Tool, issued to Simpson discloses a combination hammerhead and claw, a first set of plier gripper jaws, a wire stripper and a pipe reamer. This patent discloses a line of combination tools in the prior art that would be considered prior art for the present invention. The prior art relates primarily to combination tools sold packaged a complete tool while the present invention is primarily an attachment device to be added to one of many types of tools used by electricians.

None of the prior art listed is an attachment device to an already existing tool. An attachment device allows the electrician to use the present invention on the tool of choice for the electrician.

While the electrician is working, it is common for the electrician to carry several tools to complete the job. Installing an electrical outlet boxes on new construction, for example, the electrician will route the wire throughout the structure preferably before the walls are completed. The wiring once in a space will be routed to the location of an outlet box or specific location for a source of electricity. The routing process will most likely involve the pulling of cable around the walls of the space and setting the cable into place with staples or other types of affixing devices. A hammer is used during this process and the electrician would pull out a hammer when needed and use the hammer on the nail, staple or other affixing type device. When the hammer is done being used the electrician would then put the hammer away or the device would be used on a terminal box to affix the terminal box or similar component where the electrical cables would be routed to install those devices.

While a box is being installed and the cable routed through the box, the electrician would most likely need to use a cable cutters, crimpers to connect the wiring to the switch or outlet. The electrician would need to use several tools during this period and each time the electrician is required to switch tools the electrician would need to put one tool away, grab another tool and so forth. The electrician needing to retrieve a hammer and cable cutters could eliminate the need to repetitively pull out and put away the two most used tools in the electricians tool supply.

Additionally, the combination of the hammer and the cable cutters eliminate the need to carry an additional tool around the work site by the electrician. This saving may seem insignificant but the carrying around of two or more pound of a hammer can minimize the energy spent in carrying around the extra weight. Finally, the space saved by not carrying around the hammer can be used for other tools if the electrician needs to do so.

Electricians are trained in many different ways and each electrician has a preference developed over time about the type of tool the electrician would like to use at a work site. The use of a cable cutting tool and a hammer are fairly consistent in the field. However, the diversity in the number and types of cable cutters is one that is reflected in the types of work done by an electrician and the experience and training the electrician might receive. Therefore, it is not unusual for an electrician to develop a preference for a specific type of cable cutting tool. This device allows the electrician to use the preferred tool already within the electrician's tool supply

The final

### SUMMARY OF THE INVENTION

The present invention is an attachment device that can be placed upon a tool, preferably a cable cutting tool, which replaces a hammer in an electrician's tool supply or eliminating the need for an electrician to carry a hammer around a job site. The attachable hammer head is made from a solid piece of metal in which there is flat hammer head with a set of flanges on the opposite side of the hammer head in which there is a channel between the flanges and one or more threaded holes within the flanges. The back blade of the wire cutters is placed within the channel and a set screw is in the one or more threaded holes. The set screws are tightened onto the blade affixing the solid mass of metal onto a wire cutter and allowing the user to efficiently use one tool for hammering wire cutting. The attachable hammer head is able to be removed as needed by the user.

### BRIEF DESCRIPTION OF THE SEVERAL VIEWS OF THE DRAWINGS

FIG. 1 is an elevational side view of a hammer head attachment affixed to a blade of a cable cutter with a pair of handles and blades in an open position.

FIG. 2 is an elevational side view of the hammer head attachment affixed to a blade of a cable cutter with the handles and blades in a closed position.

FIG. 3 is a bottom view of the hammer head attachment affixed to a blade of a cable cutter.

FIG. 4 is side view of a hammer head attachment device showing the set screw.

FIG. 5 is an end view of the hammer head attachment device.

FIG. 6 is a top plan view of the hammer head attachment device.

### DETAILED DESCRIPTION OF THE INVENTION

The Figures and the description of the device and its operation include those components and processes necessary for understanding how the device functions and does not include every possible configuration or operation that could be deployed and would be readily understood by those skilled in the art.

The present invention, a hammer head attachment 30 is shown on a typical pair of cable cutters 20. The cable cutter 20 consists of two pieces, typically made from a hard metal like steel, that are joined together by a pivot pin 23. On one end of both pieces of metal is a handle 21 and 22. On the other end of the two pieces of metal are blades 24 and 25. A back blade is a part of the blade on the opposite end of the cutting edge of the blade. When the handles come together around the pivot point, the blades are brought together and the two blades act as a wire cutter. This type of design is prevalent throughout the cable cutting tool prior art and no claims are being made toward this concept.

In addition to the ability to cut wire, the cable cutter can have a number of other functions including, crimping or crushing together devices used to join or connect separate wire ends. The crimping function can be accomplished by using crimpers 26 and 27 that come together when the handles of the two metal pieces come together. When the handles are together, the cable cutter is in the closed position. When the handles are pivoted away from each other, the cable cutter is in the open position.

The present invention is meant to incorporate all of the function of commercially sold cable cutters and is not meant to limit the application of the present invention to a single type of cable cutter.

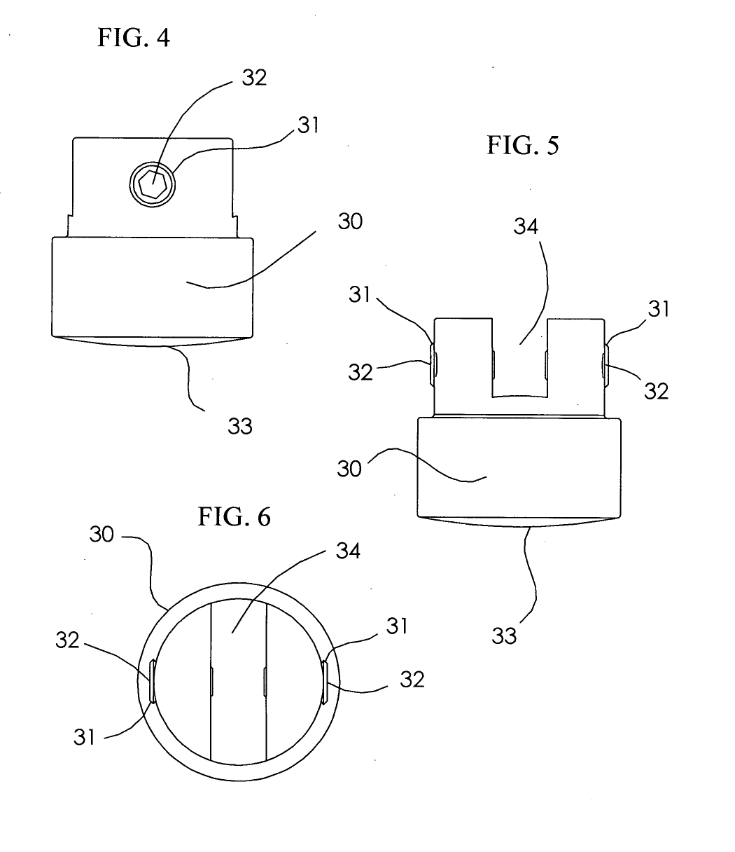

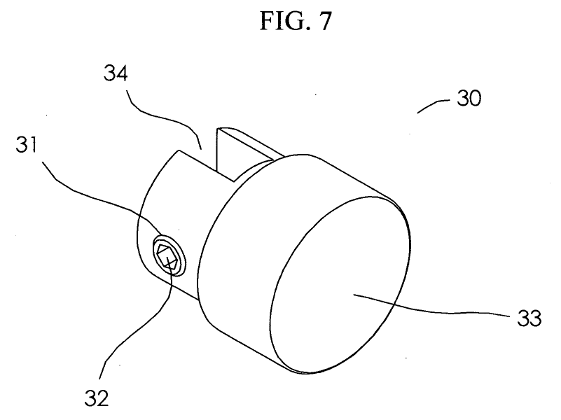

The present invention is a hammer head attachment device 30 that is able to be attached and removed from a cable cutter 20 for a combination tool. The attachment device 30 consists of a hard metal object that is shaped like a bell but made from solid metal, see FIGS. 4 through 6.

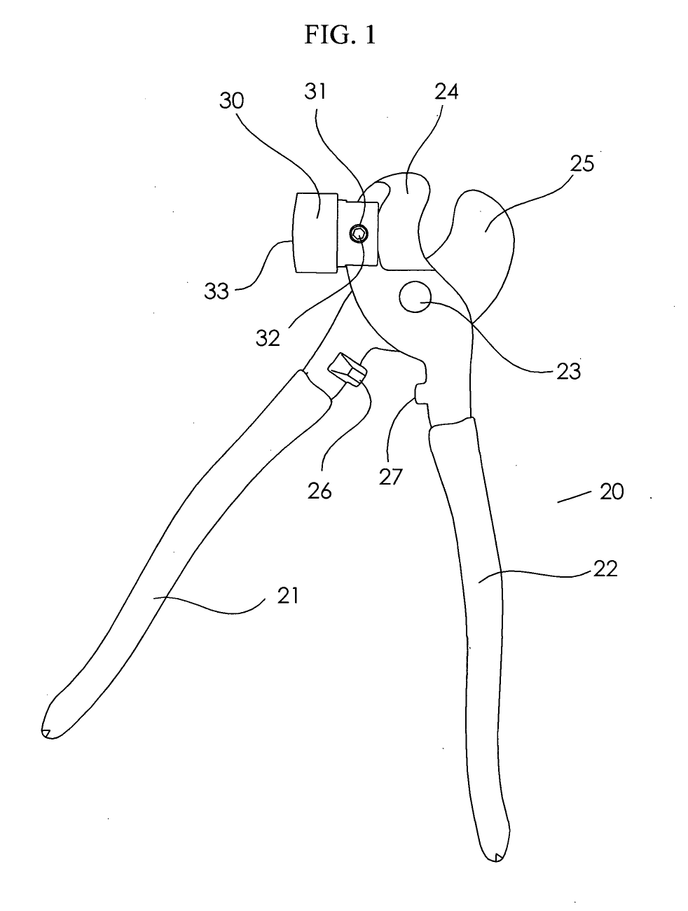

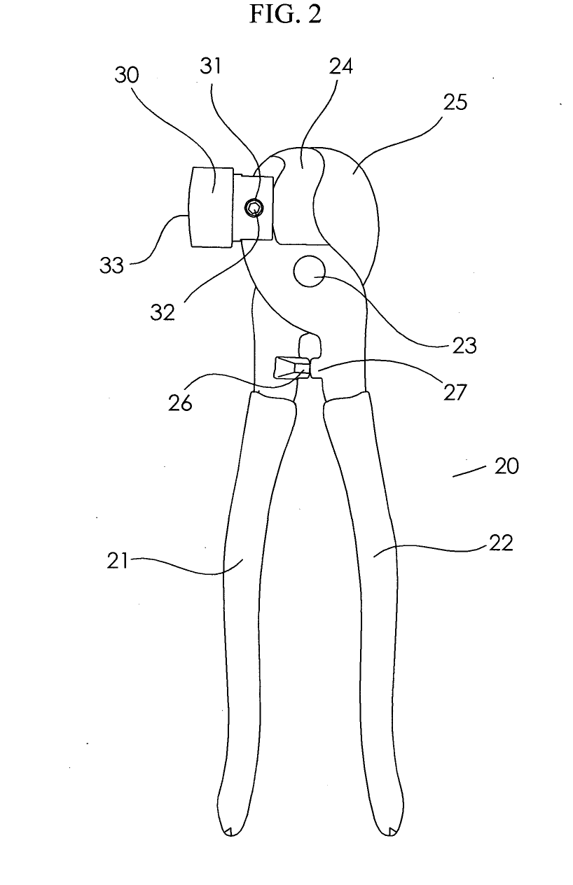

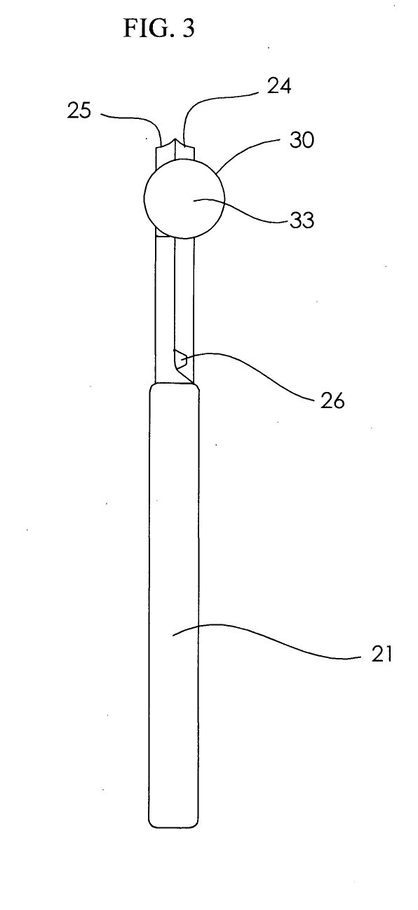

From FIGS. 4 through 6, the bell shaped attachment device 30 has a pair of holes 31 placed through a pair of upper flanges 35 connected to a solid hammer head 33. In the preferred embodiment, each flange has a hole that is cut parallel to the hammer head or perpendicular to the blade in which the hammer head attachment device is affixed. The flanges are affixed or part of the solid hammer head and located on an opposite side of the head 33 that is used to hammer. The upper flanges are spaced so as to accommodate attachment to the blade 24, as shown on FIGS. 1 and 2.

There is a channel 34 between the two upper flanges. The back blade is placed into the channel between the flanges. The holes 31 in the flanges are threaded for placing a set screw 32 type securing device in the threaded holes 31. In the preferred embodiment, a hex screw is used to secure the device to the cable cutter. In the preferred embodiment, a blade 24 is located at one end of the two pieces of metal that are used in the cable cutter 20. The blade 24 is located on one side of the metal piece with the sharpest edge being on an inner side of the piece of metal. When the handles are closed, the sharp edges of the blades 24 and 25 pass by one another and the sharp edges act like a shearing device and cutting material placed between the blades. On the opposite sides of the sharp edges, the blades are generally dull and thick, this is the back blade—see FIG. 1. It is the back blade or thick side of the blade in which the attachment device 30 is placed.

The back blade is placed within the channel 34 of the attachment device when the threaded securing devices 32 are not screwed within the channel. Once the thick part of the blade is placed within the channel, the screws 32 are tightened down on the hard metal of the thick part of the blade. In the preferred embodiment, two screws are used, one on each flange and tightened on both sides of the thick portion of the cable cutter. This tightening is done to secure the hammer head attachment device to the cable cutter. The type of securing device used in the preferred embodiment can be substituted by many other type of securing devices, including; slotted, Philips, tori, Robertson and others screws, known to those skilled in the art.

Once the attachment device is secured, the cable cutter tool is able to function as a hammer and can be used in place of a hammer.

It has also been contemplated that the combination of the hammer head attachment device and the cable cutter device could be manufactured as one solid piece.

The material for the device needs to be one of hard metal, preferably steel and specifically steel used in the manufacture of cable cutters and hammers.

I claim:

1. An attachable hammer head for a wire cutter comprising:
a wire cutter with two blades wherein the blades have a sharp edge and a back blade opposite from the sharp edge;
a solid shaped mass of hard metal as the attachable hammer head;
a flat bottom side of the solid shaped mass used as a hammer head;
an upper side of the solid shaped mass having a pair of flanges that are attached to the head and aligned perpendicular to the head;
a channel between the two flanges,
one or more threaded holes within the flanges; and
set screws in the one or more threaded holes;
wherein the solid shaped mass of hard metal is attached to the wire cutters by placing the back blade between the flanges within the channel and tightening the one or more set screws onto the blade.

2. The attachable hammer head for a wire cutter of claim 1 wherein the hammer head is removed from the wire cutter by loosening the one or more set screws.

3. The attachable hammer head for a wire cutter of claim 1 wherein the set screws are a hex screw.

4. The attachable hammer head for a wire cutter of claim 1 wherein the one or more threaded holes are set parallel to the hammer head within one or both flanges.
